(19) United States
(12) Patent Application Publication
(10) Pub. No.: US 2001/0009652 A1
(43) Pub. Date: Jul. 26, 2001

(54) APPARATUS AND METHOD FOR POINT-OF-USE ABATEMENT OF FLUOROCOMPOUNDS

(76) Inventor: JOSE I. ARNO, BROOKFIELD, CT (US)

Correspondence Address: STEVEN J HULTQUIST, INTELLECTUAL PROPERTY TECHNOLOGY LAW, P O BOX 14329, RESEARCH TRIANGLE PARK, NC, 27709

(21) Appl. No.: 09/086,033

(22) Filed: May 28, 1998

(51) Int. Cl. B01D 53/68; B01D 53/70

(52) U.S. Cl. 423/240 R; 423/241

(57) ABSTRACT

A system for abating fluorocompound, e.g., fluorine or gaseous fluorine-containing compounds, in an effluent gas stream containing same, by scrubbing of the effluent gas stream with an aqueous scrubbing medium in the presence of a reducing agent, e.g., sodium thiosulfate, ammonium hydroxide, or potassium iodide. The abatement system of the invention has utility in the treatment of semiconductor manufacturing process effluents containing fluorine and/or fluorocarbon gas species.

### BACKGROUND OF THE INVENTION

1. Field of the Invention

This invention relates generally to abatement of fluorocompounds such as fluorine and gaseous fluorides from effluent streams containing same, and more specifically to the use of a wet scrubber apparatus and method for abating fluorocompounds in semiconductor manufacturing, e.g., semiconductor manufacturing plasma processes.

2. Description of the Related Art

Perfluorinated gases are widely used in chip manufacturing to generate in-situ F₂ and fluorine radicals using plasma-assisted reactions. These highly reactive species are produced to remove silica from tool chambers or to etch materials such as nitrides, oxides, or polysilicon from wafers. The most commonly used carbon-based perfluorinated species include CF₄, C₂F₆, and C₃F₈. Nitrogen trifluoride (NF₃) and sulfur hexafluoride (SF₆) are also widely used. Perfluorinated compounds (PFCs) are also among the strongest greenhouse gases with global warming potentials (GWPs) three and four orders of magnitude higher than CO₂. Moreover, PFCs are extremely stable molecules having lifetimes in the atmosphere of thousands of years. Even though the semiconductor industry is not the largest source of PFC emissions, the industry is actively pursuing strategies to reduce PFC emissions and to protect the environment.

Ongoing research to reduce PFC emission levels falls into four categories: optimization, use of alternative chemicals, recovery/recycle techniques, and abatement processes. Process optimization involves adjusting the operating conditions in the reactor to achieve enhanced PFC conversion within the semiconductor manufacturing tool. Existing non-optimized conditions in the semiconductor manufacturing process result in PFC utilization that varies depending on the specific gas and process used. For instance, oxide etches using a combination of CF₄ and CHF₃ rank lowest with 15% process efficiency. Tungsten deposition processes are reported to utilize up to 68% of NF₃. Recent developments in optimized plasma clean technologies were demonstrated to provide up to 99% NF₃ utilization within the semiconductor manufacturing tool.

High PFC conversions inevitably result in the formation of hazardous air pollutants (HAPs). Breakdown products include mostly fluorine (F₂) and silicon tetrafluoride (SiF₄) gases and to a lesser extent HF and COF₂. Destruction of fully fluorinated gases generates considerably augmented HAP yields compared to the initial PFC volumes delivered to the semiconductor manufacturing tool. For instance, assuming stoichiometric conversion of PFCs into F₂, a 1 liter per minute (lpm) flow rate of NF₃ could potentially produce 1.5 lpm of F₂. The combined exhaust stream of four chambers in a semiconductor manufacturing process system could potentially generate up to 6 standard liters per minute (slm) of fluorine gas resulting in a post-pump effluent concentration of 3% F₂ (50 lpm ballast N₂ per pump). These estimated values double with hexafluorinated PFCs (compared to NF₃) and are likely to increase in the future with the projected throughputs of 300 mm wafer manufacturing. These estimates represent worse case scenarios and do not account for the short duration and periodic nature of processes using PFCs, the lower concentrations of F₂ emissions during initial cleaning stages, and the reduced probability that two or more chambers run PFC cycles synchronized. Nonetheless, such estimates indicate the serious and worsening character of the PFC problem associated with semiconductor manufacturing operations.

The toxic and corrosive nature of fluorinated HAPs pose considerable health and environmental hazards in addition to jeopardizing the integrity of exhaust systems. In particular, the oxidizing power of F₂ is unmatched by any other compound used or generated in the semiconductor manufacturing facility, and is far more reactive than other halogens. The large volumes of F₂ and other fluorinated hazardous inorganic gases released during optimized plasma processing require the utilization of point of use (POU) abatement technologies in order to minimize potential dangers and to prolong tool operating life.

There are several potential alternative methods for point of use F₂ abatement. At high concentrations, fluorine reacts exothermically with all elements except O₂, N₂, and noble gases. Consequently, a reasonable approach to F₂ abatement is to remove this highly active gas using naturally-occurring reactions without adding energy to the system. The main challenges to this potential approach are heat dissipation and forming acceptable by-products.

Alternative fluorine abatement techniques affording potential solutions to the fluorine abatement problem include wet as well as dry reaction techniques, and thermal reaction techniques.

In dry processing, the fluorine gas stream is flowed through a dry bed filled with a reactive material. Suitable dry chemicals would convert F₂ into innocuous solids or benign gases without generating excessive heat. This last condition could be a limiting factor especially when large volumes of F₂ are involved.

In a thermal reaction approach, thermal abatement units combine reactive materials and F₂ inside a reactor heated using fuel or electrical energy. The by-products generated by the thermal abatement of F₂ typically include hot acids requiring the use of a post-reaction water scrubber. The removal efficiencies in these post-reaction water scrubber beds are often compromised, inasmuch as the scrubbing efficiency of most acid gases decrease as a function of temperature. In addition, containment of hot concentrated acids requires expensive materials and construction to prevent temperature-enhanced corrosion attack.

In wet processing techniques, advantage is taken of the fact that fluorine gas reacts quickly and efficiently with H₂O. The main products of the reaction between water and F₂ are HF, O₂, and H₂O₂. Objections to using water scrubbers include concerns over the formation of unwanted OF₂, and the water consumption necessary to achieve acceptable removal efficiencies at high fluorine challenges.

Comparison of the foregoing treatment options shows that wet scrubbing techniques are potentially the most attractive, provided that the OF₂ by-product formation and high potential water consumption problems can be resolved.

There is, accordingly, a need in the art for a point of use wet scrubber fluorine abatement system that inhibits the formation of unwanted OF₂, that has an acceptable fluorine removal efficiency at high fluorine concentrations and that concurrently minimizes water usage.

### SUMMARY OF THE INVENTION

The present invention relates to an apparatus and method for abatement of fluorocompounds such as fluorine and gaseous fluorides from effluent streams containing same.

In one aspect, the invention relates to a process for abatement of fluorocompound from an effluent stream containing same, including contacting the gas stream with an aqueous medium in the presence of a reducing agent, such as sodium thiosulfate, ammonium hydroxide, potassium iodide, or the like.

In another aspect, the invention relates to an apparatus for abatement of fluorocompound in an effluent stream containing same, including a water scrubber unit joined in flow relationship with the stream of fluorocompound-containing effluent and arranged for discharge of a fluorocompound-depleted effluent stream, with means for injecting a reducing agent such as sodium thiosulfate, ammonium hydroxide, potassium iodide, or the like into the water scrubber unit to abate the fluorocompound therein and provide an enhanced extent of removal of the fluorocompound, relative to a corresponding system lacking such reducing agent injection.

A further aspect of the invention relates to a semiconductor manufacturing facility, comprising:

a semiconductor manufacturing process unit producing an effluent gas stream containing a fluorocompound; and

an apparatus for abating fluorocompound in the effluent gas stream, comprising:

a water scrubber unit for gas/liquid contacting;

means for introducing the fluorocompound-containing effluent gas stream to the water scrubber unit;

means for discharging a fluorocompound-reduced effluent gas stream from the water scrubber unit; and

a source of a reducing agent, operatively coupled with the water scrubbing unit and arranged for introducing reducing agent to the water scrubber unit during operation thereof.

The semiconductor manufacturing process unit in such facility may be of any suitable type, as for example a plasma reaction chamber, chemical vapor deposition chamber, vaporizer, epitaxial growth chamber, or etching tool.

Other aspects, features and embodiments of the invention are more fully shown hereinafter, and will be more fully apparent from the ensuing disclosure and appended claims.

### BRIEF DESCRIPTION OF THE DRAWINGS

FIG. 1 is a schematic of a test setup used to characterize effluent gases and temperature profiles during abatement of F₂ and SiF₄.

FIG. 2 is a sectional perspective view of a water scrubber system according to one embodiment of the invention.

FIG. 3 is a graph of outlet fluorine equivalent, in parts per million, as a function of fluorine inlet concentration.

FIG. 4 is a graph of concentration in ppm as a function of time for selective compounds measured at the outlet of a scrubber unit operated in accordance with the present invention.

### DETAILED DESCRIPTION OF THE INVENTION, AND PREFERRED EMBODIMENTS THEREOF

The present invention utilizes chemical injection to enhance the abatement of fluorocompounds in water scrubbing treatment of fluorocompound-containing effluent gas streams. The invention is usefully employed in semiconductor manufacturing operations in which fluorocompound-containing effluent gas streams are produced and require treatment for discharge or compliance with applicable environmental effluent standards.

In contrast to the inability of standard water scrubbing techniques to remove high concentrations of fluorine and other fluorocompounds, the present invention achieves a substantial improvement in the art by enhancing the performance of the water scrubber system and reducing the formation of unwanted by-products in the operation of such system.

While the invention is primarily and illustratively described hereinafter in application to the abatement of fluorine gas in an effluent stream containing same, the process and apparatus of the invention may be employed to abate other fluorocompounds as well as other strong oxidizing gases and liquids.

In addition, while the invention is illustratively described hereinafter as a stand-alone scrubbing unit, the scrubber apparatus and process of the invention may be used in combination with other processes and apparatus, such as for example, as pre-thermal abatement and post-thermal abatement water scrubber columns utilized in conjunction with a thermal processing unit.

In the present invention, a reducing agent is utilized to increase the abatement efficiency of fluorine or other fluorocompound, and to inhibit the formation of OF₂. The reducing agent can be injected as a solid or as a solution, utilizing reducing agents that are stable to air-oxidation. The reducing agent may comprise any suitable reducing agent that is effective to enhance the removal of fluorocompound in an aqueous scrubbing environment. Examples of preferred reducing agents include sodium thiosulfate, ammonium hydroxide, and potassium iodide. The most preferred reducing agent is sodium thiosulfate, a non-toxic, non-alkali, readily available, and inexpensive compound.

The apparatus of the invention for abatement of fluorocompound in the effluent stream being treated may include means for monitoring fluorocompound concentration or presence in the fluorocompound-containing effluent gas stream, and responsively adjusting the introduction of reducing agent to the water scrubber unit.

Such means may for example include a pH monitoring device for monitoring the pH of the effluent stream to be treated and responsively introducing the reducing agent at a rate and in an amount correlative to the sensed pH value.

Alternatively, such means may include an exhaust gas monitor for determining the amount of the fluorocompound in the effluent stream and responsively introducing the reducing agent to the effluent stream in an amount and at a rate determined by the sensed concentration of the fluorocompound.

In general, the means for monitoring fluorocompound concentration in the fluorocompound-containing effluent gas stream, and responsively modulating the introduction of reducing agent to the water scrubber unit, may be widely varied, and utilized to minimize the amount of added reducing agent in the abatement of the fluorocompound in the effluent stream.

The present invention achieves efficient abatement of fluorocompounds such as fluorine using reducing agents that enhance fluorine abatement (relative to water scrubbing in the absence of such chemical agent) while maintaining acceptable levels of OF₂.

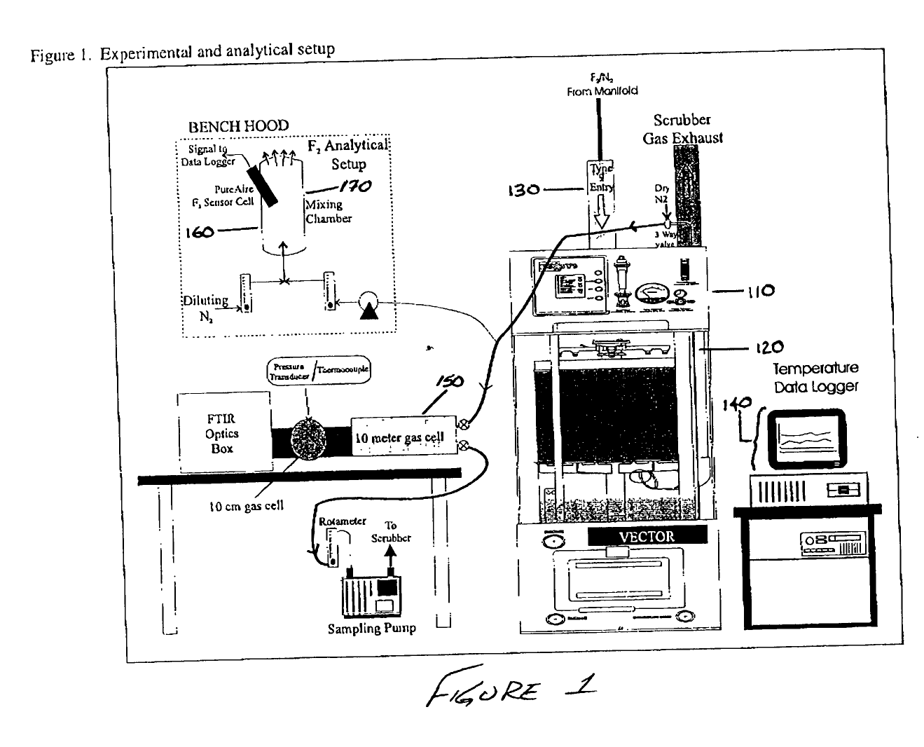

FIG. 1 schematically illustrates an apparatus used to characterize effluent gases and temperature profiles during the abatement of F₂ and SiF₄. An automated gas delivery manifold equipped with mass flow controllers is used to generate the nitrogen and F₂ or SiF₄ mixtures introduced into the scrubber. A water scrubber unit 110 is provided for effluent stream treatment. At the exhaust of the water scrubber unit 110 is a packed bed counter-current flow polishing unit 120.

In order to minimize corrosion at the inlet of the scrubber, the metal portion 130 of the inlet may be coated with nickel or other corrosion-resistant material.

Gas and water temperatures within the scrubber are measured at selected points in order to monitor the process during the abatement process. The abatement system may be monitored by any suitable means, e.g., a process monitoring and control system including computer 140.

Infrared active gas phase species present at the scrubber exhaust are drawn into an FTIR spectrophotometer, e.g., a MIDAC I-2000 FTIR spectrophotometer, commercially available from MIDAC Corporation, for quantitative analysis. The unit is equipped with a nickel-coated gas cell 150 having a ten-meter pathlength, with ZnSe windows, and a liquid nitrogen-cooled MCT detector. The spectrometer is set at appropriate monitoring settings, e.g., to average 16 scans covering the spectral region between 600 and 4200 cm⁻¹ at a resolution of 0.5 cm⁻¹. Full spectra are periodically collected, e.g., every 30 seconds, to provide continuous, real-time information on the nature and concentration of the species of interest. Accurate quantitative analyses are suitably achieved by calibrating the analyzer in situ using known SiF₄ and HF concentrations. Oxygen difluoride (OF₂) absorbencies are converted into concentrations using a quantitative spectral library issued by MIDAC Corporation.

Fluorine gas is analyzed in a continuous mode using a gas sensor cell 160 such as an F₂ specific Pure Air gas sensor cell (Pure Air Monitoring Systems, Inc.). This electrochemical sensor utilizes gas membrane galvanic cell technology to monitor low concentrations of toxic gas. The sensor is specially designed for in situ monitoring of F₂ under water vapor-saturated conditions. In order to provide continuous analyses within the detection limit of the monitoring device (3 ppm F₂), known flow rates of scrubber gas exhaust are diluted with metered nitrogen flows. The combined stream is introduced into a mixing chamber 170 equipped with the F₂ sensor. The monitor responds to changing F₂ concentrations. The concentration data are logged into the computer at 30 second intervals. Accurate quantitative results are achieved by calibrating the sensor against known concentrations of F₂.

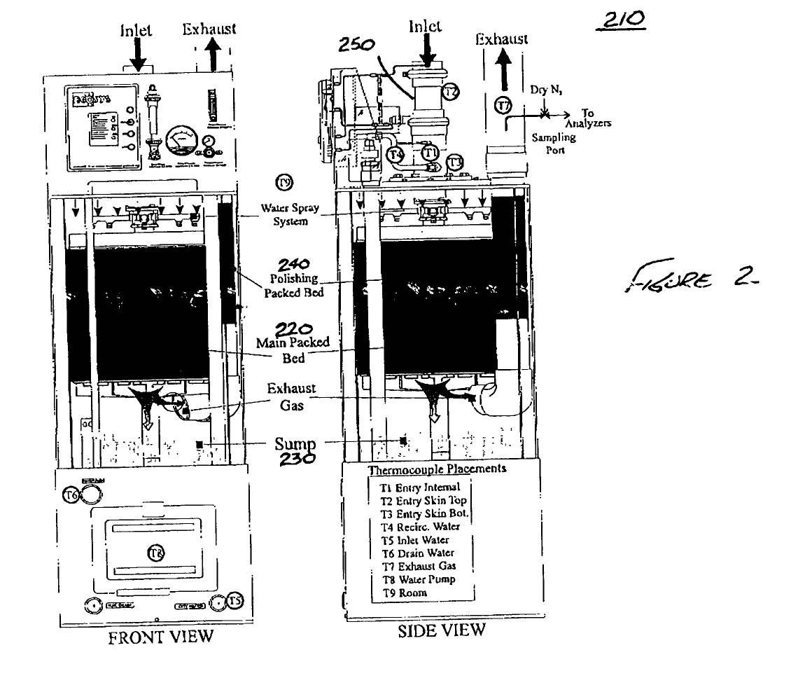

FIG. 2 is a further detailed illustration of a water scrubber 210, which is of a type similar to the water scrubber unit 110 shown in the FIG. 1 system. The water scrubber operates using a vertical co-current flow of water and the contaminated gas stream. Water active species are hydrolyzed as they interact with water in a high surface area packed region 220. The resulting liquid falls to a water reservoir or sump 230, and the resulting scrubber gas stream exits the scrubber through a vertical duct connected to a blower. The water dynamics of the water scrubber include fresh or make-up water flowing into the system, water draining out, and continuous recirculation of water stored in the sump 230. The performance of the scrubber is enhanced using a counter-current packed polishing bed 240 installed at the gas exhaust. The inlet 250 is nickel-coated to minimize solid deposits and protect the entry from corrosive attack. Gas and water temperatures within the scrubber are measured at nine selected points as identified in FIG. 2.

The features and advantages of the present invention are more fully shown with respect to the following illustrative examples.

### EXAMPLE 1

In a system of the general type shown in FIGS. 1 and 2, abatement of SiF₄ was carried out using an effluent stream simulating effluent produced in a semiconductor manufacturing facility by cleaning of plasma reaction chambers.

Table 1 below summarizes results for the abatement (destruction and removal efficiency, % DRE) of SiF₄, with and without the injection of caustic. The abatement in this instance did not include the introduction of a reducing agent.

Fixed concentrations (300 ppm) of silicon tetrafluoride balanced with 120 slpm of nitrogen were introduced into the water scrubber. The experimental conditions were chosen to represent or exceed effluent gas concentrations released during typical plasma chamber cleans. Abatement efficiencies were measured as a function of water flow rates (0.5 and 1 gpm), and scrubber pH (with and without caustic injection). In all cases investigated, measured scrubber outlet concentrations of HF and SiF₄ were slightly above the detection limits of the spectrometer and significantly below their respective threshold level values (TLV) (SiF₄ TLV=1 ppm, HF TLV=3 ppm).

TABLE 1
Summary of Abatement Results at Fixed Inlet Challenge of
300 ppm SiF₄ in 120 slpm N₂.

| | Caustic | | | SiF4 | |
|---|---|---|---|---|---|
| Water Flow rate | Injection? | | HF conc. | conc. | |
| (gpm) | (pH) | | (ppm) | (ppm) | % DRE |
| 1 | No | (3.85) | 0.47 | 0.3 | 99.86 |
| 0.5 | No | (3.50) | 0.46 | 0.3 | 99.86 |
| 1 | Yes | (10.5) | 0.15 | 0.1 | 99.95 |
| 0.5 | Yes | (10.8) | 0.13 | 0.075 | 99.96 |

### EXAMPLE 2

Fluorine gas flow rates ranging between 0.5 to 5 slpm were delivered into a Vector®-100 water scrubber (ATMI Ecosys Corporation, San Jose, Calif.) that was equipped with a passivated manifold. These streams were diluted with 50 slpm of balanced nitrogen resulting in challenges between 1 and 6% F₂. In addition, the effects of residence time within the scrubber were studied by increasing the nitrogen flow rate to 200 slpm. The performance of the scrubber unit was tested using standard (1.2 gpm) and low (0.75 gpm) water flow rates. Sodium thiosulfate was used during high fluorine gas challenges to improve fluorine gas removal and to eliminate the formation of OF₂ as a by-product.

Table 2 summarizes the experimental data, and illustrates the enhancement achieved by injection of sodium thiosulfate as a reducing agent.

TABLE 2
Summary of Fluorine Abatement Results

| | | | | | | HF | | OF₂ | Outlet | |
|---|---|---|---|---|---|---|---|---|---|---|
| | Water | N₂ | F₂ Flow | | Chem. | Out. | F₂ Out. | Out. | F₂ | |
| Test | Flow | Balance | Rate | F₂ inlet | Enhance | Conc. | Conc. | Conc. | Equiv. | % |
| # | (gpm) | (slpm) | (slpm) | (ppm) | ? | (ppm) | (ppm) | (ppm) | (ppm) | DRE |
| 1 | 1.2 | 50 | 1 | 20000 | No | 7.5 | 1.5 | 1.25 | 6.5 | 99.97 |
| 2 | 1.2 | 50 | 2 | 40000 | No | 12 | 2.5 | 3 | 11.5 | 99.97 |
| 3 | 1.2 | 50 | 3 | 60000 | No | 15 | 20 | 4 | 31.5 | 99.95 |
| 4 | 0.75 | 50 | 0.5 | 10000 | No | 4 | 0.5 | <1 | 3.5 | 99.97 |
| 5 | 0.75 | 50 | 1 | 20000 | No | 6 | 1 | 1 | 5 | 99.98 |
| 6 | 0.75 | 50 | 2.25 | 45000 | No | 20 | 5 | 5 | 20 | 99.96 |
| 7 | 0.75 | 50 | 3 | 60000 | No | 28 | 50 | 10 | 74 | 99.88 |
| 8 | 0.75 | 50 | 2.25 | 45000 | Yes | 2.25 | 0.5 | <1 | 1.6 | 99.996 |
| 9 | 0.75 | 200 | 3 | 15000 | Yes | 25 | 38 | <1 | 50.5 | 99.7 |
| 10 | 0.75 | 200 | 5 | 25000 | Yes | 42 | 120 | <1 | 141 | 99.4 |

Percent destruction and removal efficiencies (% DREs) were determined using the standard expression

$$\% DRE = 100 \times ( 1 - \frac{Outlet {F}_{2} Equiv .}{Inlet {F}_{2} } )$$

where Inlet F₂ represents fluorine inlet concentration in ppm, and Outlet F₂ Equiv. is defined as:

Outlet F₂ Equiv.=[Outlet F₂ conc.]ₚₚₘ+½[Outlet HF conc.]ₚₚₘ+[Outlet OF₂ conc.]ₚₚₘ

Under all conditions investigated, the water scrubber removes over 99% of the fluorine delivered. It should be noted that the removal efficiencies set out in Table 2 represent performance of the reducing agent-enhanced water scrubber treatment of the invention under worst case scenarios with respect to the effluent gases released during a conventional plasma chamber clean.

Most importantly, the tabulated outlet concentrations represent the equilibrium values reached after extended and continuous delivery of fluorine gas into the scrubber. This steady state typically is achieved between 10 and 30 minutes after the start of tests depending on the initial F₂ concentration. The duration of chamber cleans are often a fraction of the time necessary to reach that equilibrium.

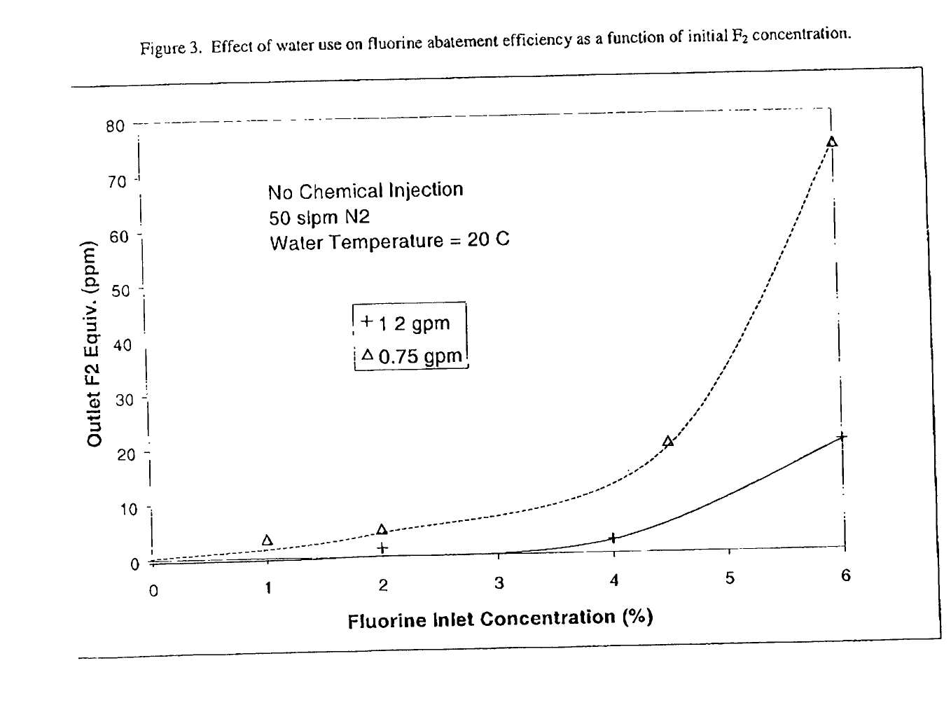

FIG. 3 illustrates the effect of water use on fluorine abatement efficiency. As expected, make-up water flow rate affects scrubbing efficiency and is a limiting factor under high fluorine challenges. Without chemical enhancement, OF₂ concentrations at the outlet of the scrubber exceed 3 ppm when delivering approximately more than 3% and 6% F₂ (50 slpm N₂ ballast) using 0.75 and 1.2 gpm water respectively. Tests 8 to 10 (see Table 2) demonstrate that chemical injection inhibits OF₂ formation in addition to enhancing scrubbing efficiency. For example, the experimental conditions of tests 6 and 8 are identical with the exception of delivery of the chemical enhancer. Chemical injection decreases the outlet concentrations of HF and F₂ by a factor of 10 and decreases OF₂ concentration to below detection limits.

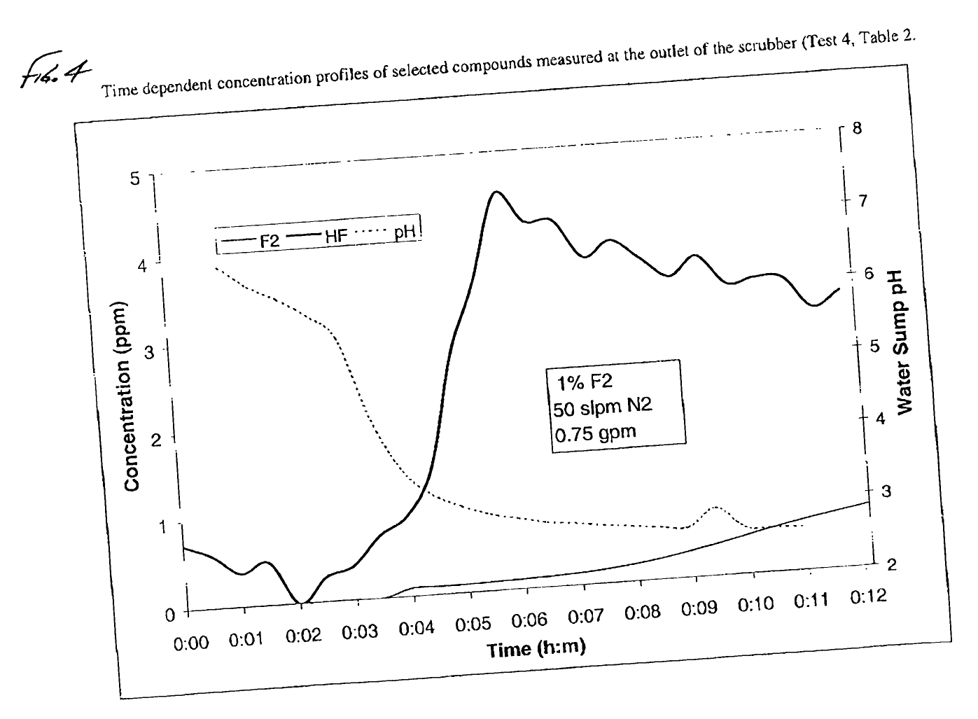

FIG. 4 shows the scrubber sump pH and exhaust concentration of HF and F₂ as a function of time. The graph demonstrates that breakthrough of gases is significantly delayed and a function of water pH. Second, the time-dependent concentration of F₂ released during typical chamber cleans is not constant. During the initial stages, most F₂ produced in the chamber is used to react with SiO₂ releasing SiF₄ gas. It is only after SiO₂ is depleted, that excess F₂ is discharged by the tool in significant amounts.

Analyses of the temperature data collected during this study indicate that heat generated by exothermic reactions is effectively dissipated within the scrubber. The only measurable temperature changes were recorded inside the scrubber inlet entry at the first interface between incoming gas and water vapor. A maximum temperature increase from 17° C. to 25° C. (ΔT=9° C.) was detected during the highest fluorine challenges. The heat capacity of the large volume of recirculating water combined with heat exchange with the surroundings effectively quenched the heat generated by the hydrolysis of F₂. In addition, no significant signs of corrosion or material deterioration were found anywhere within the scrubber (including the entry system) after completion of the tests. Overall, the scrubber was exposed and efficiently abated of 3.2 lbs. (or the equivalent of 855 liters) of fluorine gas.

The foregoing data illustrate the advantages of the present invention in providing enhanced removal of fluorine gas from a fluorine-containing effluent stream.

While the invention has been described herein with reference to specific embodiments and features, it will be appreciated the utility of the invention is not thus limited, but encompasses other variations, modifications, and alternative embodiments. The invention is, accordingly, to be broadly construed as comprehending all such alternative variations, modifications, and other embodiments within its spirit and scope, consistent with the following claims.

What is claimed is:

1. A process for abating fluorocompound in a gas stream containing same, comprising scrubbing the gas stream with an aqueous medium in the presence of a reducing agent.

2. The process according to claim 1, wherein the reducing agent includes at least one compound from the group consisting of sodium thiosulfate, ammonium hydroxide and potassium iodide.

3. The process according to claim 1, wherein the reducing agent includes sodium thiosulfate.

4. The process according to claim 1, wherein the reducing agent includes ammonium hydroxide.

5. The process according to claim 1, wherein the reducing agent includes potassium iodide.

6. The process according to claim 1, wherein the reducing agent is injected into the aqueous medium during the scrubbing.

7. The process according to claim 1, wherein the fluorocompound comprises fluorine gas.

8. The process according to claim 1, wherein the fluorocompound comprises a gaseous fluoride compound.

9. The process according to claim 1, wherein the fluorocompound-containing gas stream comprises effluent of a semiconductor manufacturing process.

10. The process according to claim 1, wherein the fluorocompound-containing gas stream comprises effluent from a plasma reactor cleaning operation in a semiconductor manufacturing facility.

11. The process according to claim 1, further comprising monitoring a process condition of the gas stream and introducing the reducing agent in an amount dependent on said process condition.

12. The process according to claim 11, wherein the process condition of the gas stream is pH.

13. The process according to claim 1, wherein the process condition of the gas stream is fluorocompound concentration therein.

14. An apparatus for abating fluorocompound in an effluent gas stream containing same, comprising
a water scrubber unit for gas/liquid contacting;
means for introducing the fluorocompound-containing effluent gas stream to the water scrubber unit;
means for discharging a fluorocompound-reduced effluent gas stream from said water scrubber unit; and
a source of a reducing agent, operatively coupled with the water scrubbing unit and arranged for introducing reducing agent to the water scrubber unit during operation thereof.

15. The apparatus according to claim 14, wherein the source of reducing agent comprises a means for injecting the reducing agent into the water scrubber unit.

16. The apparatus according to claim 14, further comprising a means for monitoring fluorocompound concentration in the fluorocompound-containing effluent gas stream, and in response thereto adjusting the introduction of the reducing agent to the water scrubber unit.

17. A semiconductor manufacturing facility, comprising:
a semiconductor manufacturing process unit producing an effluent gas stream containing a fluorocompound; and
an apparatus for abating fluorocompound in said effluent gas stream, comprising:
a water scrubber unit for gas/liquid contacting;
means for introducing the fluorocompound-containing effluent gas stream to the water scrubber unit;
means for discharging a fluorocompound-reduced effluent gas stream from said water scrubber unit; and
a source of a reducing agent, operatively coupled with the water scrubbing unit and arranged for introducing reducing agent to the water scrubber unit during operation thereof.

18. The semiconductor manufacturing facility according to claim 17, wherein the semiconductor manufacturing process unit comprises a process unit selected from the group consisting of plasma reaction chambers, chemical vapor deposition chambers, vaporizers, epitaxial growth chambers, and etching tools.

19. The semiconductor manufacturing facility according to claim 17, wherein the source of reducing agent comprises a means for injecting the reducing agent into the water scrubber unit.

20. The semiconductor manufacturing facility according to claim 17, further comprising a means for monitoring fluorocompound concentration in the fluorocompound-containing effluent gas stream, and in response thereto adjusting the introduction of the reducing agent to the water scrubber unit.
